(19) United States
(12) Patent Application Publication
(10) Pub. No.: US 2008/0085124 A1
(43) Pub. Date: Apr. 10, 2008

(54) Clock generation with minimum number of crystals in a multimedia system

(75) Inventors: Ho-Ming Leung, Cupertino, CA (US); Elliot Sowadsky, San Jose, CA (US)

Correspondence Address: LSI CORPORATION, 1621 BARBER LANE, MS: D-106, MILPITAS, CA, 95035, US

(73) Assignee: LSI LOGIC CORPORATION

(21) Appl. No.: 11/545,406

(22) Filed: Oct. 10, 2006

(51) Int. Cl. H04B 10/00

(52) U.S. Cl. 398/155

(57) ABSTRACT

An apparatus comprising a first circuit and a second circuit. The first circuit may be configured to present a transport stream having (i) audio/video data, (ii) video presentation time stamps, and (iii) audio presentation time stamps. The second circuit may have one or more phase locked loop circuits and a control circuit. The control circuit may. be configured to synchronize the playback of the audio/video data by adjusting a fractional divider of one or more of the phase locked loop circuits.

### FIELD OF THE INVENTION

The present invention relates to clock generation circuits generally and, more particularly, to a method and/or apparatus for implementing a clock generator with a minimum number of crystals that may be suitable for use in a multimedia system.

### BACKGROUND OF THE INVENTION

In conventional consumer electronic products, such as DVD recorders, DVD players or set top boxes, there are many clock sources. In a conventional system, all of the clock sources need to be generated from individual crystals. The disadvantages of generating multiple clock signals from individual crystals include (i) increased costs, (ii) every crystal needing two data pins and two power/ground pins, (iii) increased PC board space, (iv) increased power consumption, (v) cross talk among different crystal oscillators, and (vi) the need for external voltage control oscillator to tune clock frequency.

It would be desirable to generate multiple clock signals using a minimum number of crystals.

### SUMMARY OF THE INVENTION

The present invention concerns an apparatus comprising a first circuit and a second circuit. The first circuit may be configured to present a transport stream having (i) audio/video data, (ii) video presentation time stamps, and (iii) audio presentation time stamps. The second circuit may have one or more phase locked loop circuits and a control circuit. The control circuit may be configured to synchronize the playback of the audio/video data by adjusting a fractional divider of one or more of the phase locked loop circuits.

The objects, features and advantages of the present invention include providing a clock generation circuit that may (i) generate a plurality of clock signals, (ii) use a minimum number of crystals, and/or (iii) be easy to implement.

### BRIEF DESCRIPTION OF THE DRAWINGS

These and other objects, features and advantages of the present invention will be apparent from the following detailed description and the appended claims and drawings in which:

FIG. 1 is a block diagram of a system;

FIG. 2 is a detailed diagram of the system;

FIG. 3 is a more detailed diagram of the system;

FIG. 4 is a diagram of a receiver and transmitter system used in transmitting video and audio data in accordance to the present invention;

FIG. 5 is a more detailed diagram of the receiver and transmitter in accordance to the present invention,

FIG. 6 is a flow diagram for audio/video synchronization; and

FIG. 7 is a flow diagram for receiver and transmitter synchronization.

### DETAILED DESCRIPTION OF THE PREFERRED EMBODIMENTS

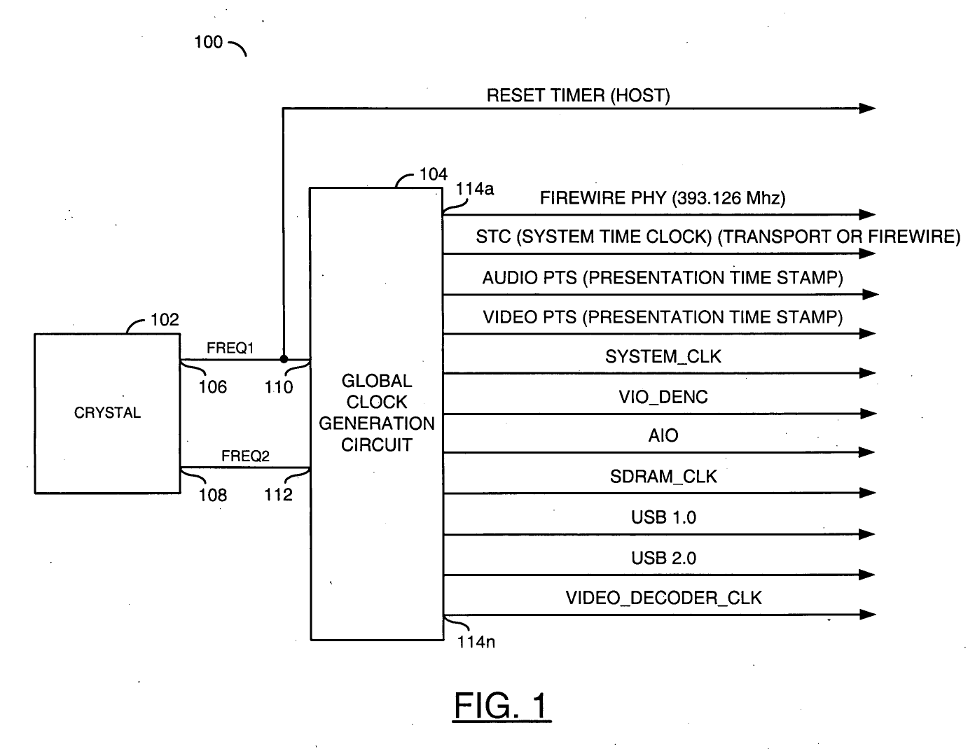

Referring to FIG. 1, a block diagram of a system 100 is shown. The circuit 100 generally comprises a block (or circuit) 102 and a block (or circuit) 104. The circuit 102 may be implemented using a plurality of crystals. The circuit 104 may be implemented as a global clock generation circuit. Each of the crystals may generate a base clock signal operating in a particular frequency. For example, the circuit 102 may have an output 106 that may present a signal (e.g., FREQ1) and an output 108 that may present a signal (e.g., FREQ2). While the signal FREQ1 and the signal FREQ2 are shown, more than two signals may be implemented from the circuit 102 to meet the design criteria of a particular implementation.

The circuit 104 may have an input 110 that may receive the signal FREQ1 and an input 112 that may receive the signal FREQ2. The circuit 104 may have a number of outputs 114a-114n that may present a number of operating clock signals. The system 100 may be implemented using only a minimum number of crystals and/or oscillators to generate a variety of operating clock signals each operating at one of a plurality of frequencies.

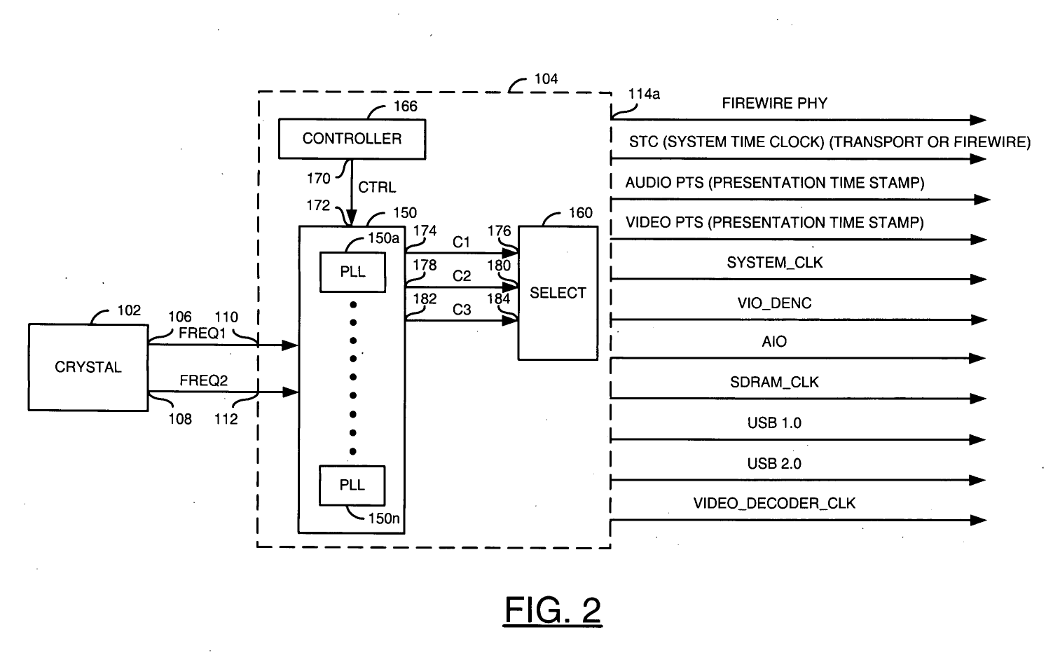

Referring to FIG. 2, a detailed diagram of the system 100 is shown. The global clock generation circuit 104 generally comprises a block (or circuit) 150, a block (or circuit) 160, and a block (or circuit) 166. The circuit 150 may be implemented as a phase-lock-loop circuit. The circuit 160 may be implemented as a select circuit. The circuit 166 may be implemented as a controller. The controller 166 may have an output 170 that may present a signal (e.g., CTRL). The PLL circuit 150 may have an input 172 that may receive the signal CTRL. The PLL circuit 150 may have an output 174 that may present a signal (e.g., C1), an output 178 that may present a signal (e.g., C2), an output 182 that may present a signal (e.g., C3). The select-circuit 160 may have an input 176 that may receive the signal C1, an input 180 that may receive the signal C2 and an input 184 that may receive the signal C3. The PLL circuit 150 generally comprises a number of PLLs 150a-150n.

In general, each PLL 150a-150n may be implemented as a fractional PLL. A fractional PLL may adjust the input frequency provided by the crystal 102 over the signal FREQ1 and FREQ2 by a non-integer. By implementing each PLL circuit 150a-150n as a fractional PLL, a designer my adjust clock signal generated by the any one of the 150a-150n PLL circuits on the fly. In one example, the controller 166 may speed up or slow down the one or more clock signals on the outputs 114a-114n by adjusting the fractional frequency of each PLL circuit 150a-150n. The frequency provided by the crystal 102 may remain constant while the frequency of the fractional PLL may be adjusted to speed up or down the clock signals. The signal CTRL may be selectively applied to any one or more PLLS 150a-150n. A bus may be used to couple the controller 166 to the PLLs 150a-150n. The bus may be implemented as a multi-bit bus. In one example, the controller 166 may selectively increase or decrease the frequency of the PLLs 150a-150n based on a corresponding bit value transmitted on the multi-bit bus. By implementing the PLLs 150a-150n as fractional PLLS, the system 100 may provide clock signals on outputs 114a-114n which provide different frequencies while maintaining a minimum number of crystals.

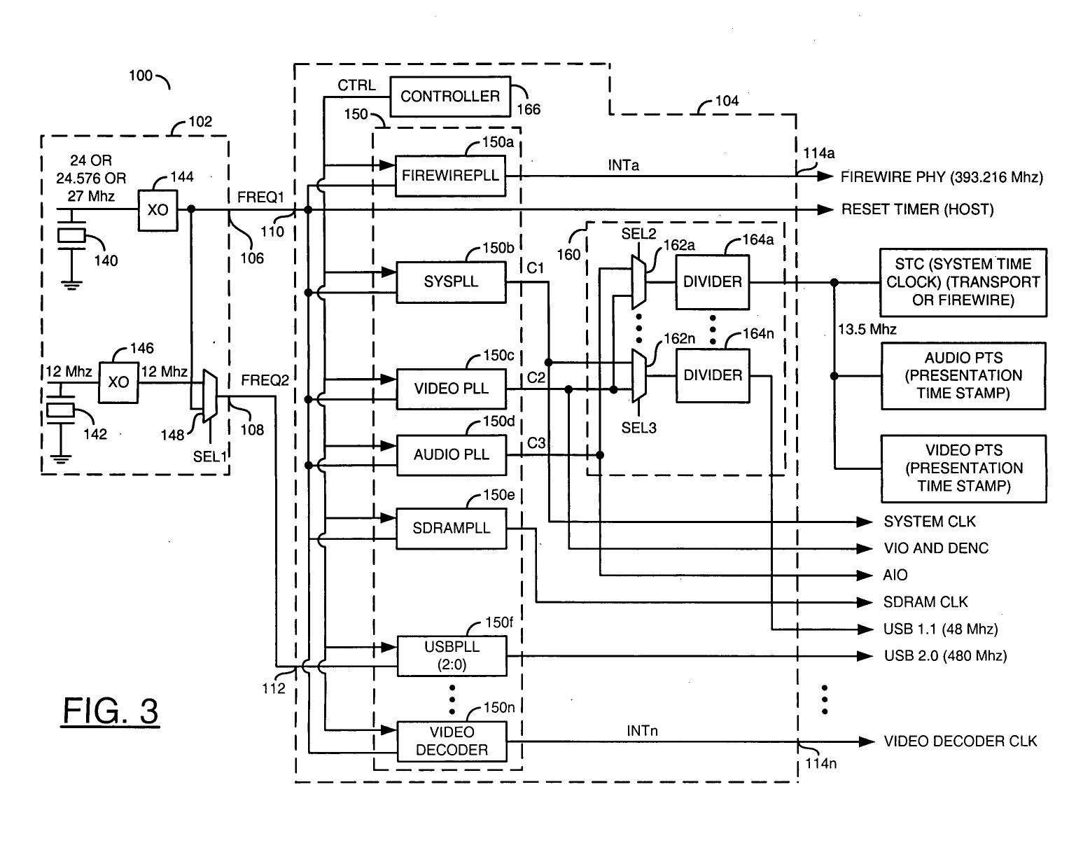

Referring to FIG. 3, a more detailed diagram of the system 100 is shown. The circuit 102 may be implemented as a crystal 140 and a crystal 142. While two crystals are shown, more than two crystals may be implemented to meet the design criteria of a particular implementation. In the example shown, the crystal 140 may be selected to operate at any of a plurality of frequencies (e.g., 24, 24.576 or 27 Mhz). The particular operating speed may be selected based on the particular frequency needed at the outputs 114a-114n. In the example shown, the crystal 142 is shown operating at a fixed frequency (e.g., 12 MHZ). While a 12 MHZ crystal is shown, the particular operating frequency of the crystal 142 may be varied to meet the design criteria of a particular implementation. A circuit 144 may be implemented to help stabilize the crystal 140. A circuit 146 may be implemented to stabilize the crystal 142. A block (or circuit) 148 may be implemented as a select circuit. The select circuit 148 may select a signal from the crystal 140 or the crystal 142 as the signal FREQ2. The select circuit 148 may respond to a select signal (e.g., SEL1).

The PLLs 150a-150n may provide clock signals on the outputs 114a-114n for a variety of different functions used in connection with a set top box. The select circuit 160 generally comprises a plurality of multiplexers 162a-162n and a plurality of divider circuits 164a-164n. Each of the multiplexers 162a-162n may be used to present signals to one of the divider circuits 164a-164n. For example, the multiplexers 162a is shown receiving a signal from the PLL 150c and the PLL 150d. A select signal (e.g., SEL2) may be used to select one of the two signals to be presented to the divider 164a. While a two input select circuit 162a is shown, a three (or even more) input select circuit may be implemented. In such an implementation, the select signal SEL2 may be implemented as a multi-bit select signal. Similarly, the select circuit 162n is shown receiving a signal from the PLL 150b and a signal from the PLL 150c. The multiplexer 162n may respond to a select signal (e.g., SEL3). Each of the PLL circuits 150a-150n generally presents one of a plurality of intermediate signals (e.g., INTa-INTn). For example, the PLL 150a may present the signal INTa, the PLL 150b may present the signal INTb and a PLL 150n may present the signal INTn. In one example, the system 100 may be implemented as a set top box. The system 100 may be configured to receive a system transport stream from a transmitter (e.g., headend) not shown. The system transport stream may include video/audio data, system time clock stamps and audio/video presentation time stamps. The system time clock stamps and the audio/video presentation time stamps may provide timing information related to the playback of the audio/video data.

The PLLs 150a-150n may be implemented as integer and/or fractional PLLs. The PLLs 150a-150n may be used to generate a variety of desired clock signals. Since each PLL 150a-150n may be fractional (e.g., programmable to generate a variety of frequencies that are not integers of a particular oscillation frequency), the frequency may be adjusted on the fly by changing the fractional divider circuit of the PLL.

The operating clock signals presented at the crystals 114a-114n may satisfy a variety of design objectives. For example, the PLL 150a (or any of the outputs 114a-114n) may provide a clock signal on the output 114a that may be used in a Firewire™ system. Firewire™ normally uses a clock signal operating at 393.216 Mhz, which is normally generated from a crystal having a frequency of 24.576 Mhz. The PLL 150a may be implemented as an integer PLL. The PLL 150a may generate the Firewire™ clock signal in response to the crystal 150 providing a reference frequency of 24.576 Mhz.

In another example, the PLL 150e may generate a clock signal (or signal SDRAM-CLK) suitable for an SDRAM. In general, there are no restrictions for the exact frequency for an SDRAM. However, it is normally desirable to use the maximum frequency allowed by the SDRAM part. Such frequencies are normally 166 Mhz, 200 Mhz, 266 Mhz etc. The PLL 150e may be implemented as a fractional PLL. The frequency of the crystal 150 may be arbitrarily set. The exact frequency of the crystal 150 may be varied to meet the design criteria of a particular implementation. In one example, the PLL 150e may generate the signal SDRAM_CLK in response to the crystal 150 operating at a frequency of 24.576 Mhz.

The PLL 150b may generate a system clock. The system clock may be used to drive embedded processors and DSPs. A typical frequency of a system clock may have a frequency similar to the clock of an SDRAM clock. In some implementations, a system clock may have a frequency that is different from the SDRAM clock in order to increase processing power or reduce processing power.

In another example, the PLL 150c (or video PLL) may generate a video clock signal (or signals VIO and DENC). Normally, the video PLL 150c may generate signals used for high definition video frequencies in the range of 74.25 Mhz, 74.25/1.001 Mhz or any multiple of these frequencies. The video PLL 150c may generate the video clock signal based on a reference crystal having a frequency of 24.576 Mhz. For standard definition frequencies, a 54 Mhz, 108 Mhz or 216 Mhz based video clock signal.

In another example, the circuit 104 may generate a Universal Serial Bus (USB) clock. If the system 100 uses USB 1.0, then 12 Mhz, 24 Mhz or 48 Mhz clock signals may be needed. Such frequencies may be generated by dividing a 216 Mhz clock signal with the divider circuit 164n by 4.5, 9 or 18. By dividing the clock signal with the divider circuit 164n, analog circuitry may not be needed. Another approach is to have the system clock or SDRAM clock running at multiples of the 12 Mhz signal and to be sub-divided down to generate the USB 1.0 clock.

In another example, the PLL 150d (or audio PLL) may generate an audio clock signal (or signal Audio Input and Output (AIO)). In another example, the PLL 150n (or video decoder PLL) may generate a decoder clock signal (or video decoder CLK). In such an example, a video decoder (e.g., NTSC, PAL decode, etc.) may operate at 24.576 Mhz. The 24.516 MHZ may be generated directly from the crystal 150 in the system 100.

In another example, the PLL 150f may generate a USB 2.0 clock. If USB 2.0 is needed, the PLL 150f may generate the USB 2.0 clock. The USB 2.0 clock may be based on a 12 MHZ or 24 MHZ crystal. If the system does not use Firewire™ or the video decoder signal is not needed, then the crystal 156 may be changed to 12 or 24 Mhz. However, if this is not the case, then a dedicated crystal and oscillator may be added.

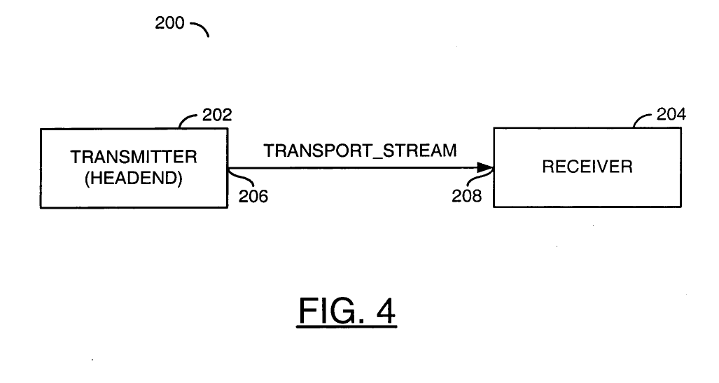

The controller 166 may adjust the frequency (by changing the value of the fractional PLL) for any of the PLLs 150a-150n on the fly. In one example, the video PLL 150c may generate a video clock signal that is equal to 216 MHZ (e.g., 24.576 MHZ*8.7890625). In another example, the controller 166 may adjust the fractional value of the video PLL 150c from 8.78 to 8.79 to speed up the video clock signal. In another example, the controller 166 may adjust the fractional value of the video PLL 150c from 8.78 to 8.77 to slow down the video clock signal. The video PLL 150c may adjust (the frequency of the video clock signal on the fly (via the controller 166) to match a headend rate of the system transport stream. The synchronization of video and audio data between a transmitter (e.g., headend) and a receiver (e.g., a set top box) will be described in more detail in connection with FIGS. 4-7.

Conventional systems may use a single crystal for providing the clock frequency to the video PLL 150c. Such conventional systems may need external oscillators. The external oscillators may need to be tuned in order to match the frequency of the headend rate of the system transport stream. The system 100 may provide cost savings over conventional approach since external oscillators and extra crystals may not be needed. In general, conventional set top boxes may include more crystals than the number of crystals shown in the system 100. Such conventional set top boxes may need a dedicated crystal for (i) USB (ii) Firewire™ and (iii) video applications.

In general, the speed of the crystals 150 and 152 may be pre-selected. For example, the crystal. 150 is shown operating at 24 Mhz, 24.576 Mhz or 27 Mhz. A designer may select one frequency for the crystal 150 to operate that would be the best for a particular system. For example, if a system only needed Firewire, but did not need USB 2.0, then an operation speed of 24.576 Mhz would be best. 24.576 Mhz is the frequency of the Firewire, so a fractional PLL may be used to generate clock signals for the video and audio. In another example, a clock for USB 1.0 may be derived by dividing a 216 Mhz video clock signal by 9. In another example in a system with USB 2.0, but no Firewire, an operating speed of 24 Mhz may be selected.

In general, a single PLL may not be suitable for a complicated system, such as a set top box, since a PLL may only generate one frequency at one time. A complicated system may need all the frequencies continuously available at all times. For example, video and audio clock signals often need to be adjusted on the fly. A single crystal with an adjustable fractional PLL may be used to implement such adjustments. For example, a video clock signal may be generated by multiplying a 24.576 Mhz clock by 8.7890625 to get 216 Mhz. An on the fly change from 8.78 to 8.79 may be used as a speed up or to get down to 8.77 for a slow down of the video clock to match the headend rate. Such a system would avoid the need for an individual crystal dedicated for the video. Such a system would also avoid the need for an external oscillator and/or tuning an external oscillator to match the frequency. The present invention normally saves the cost of at least one oscillator and crystal.

Referring to FIG. 4, a diagram of a transmitter/receiver system that may incorporate the present invention is shown. The system 200 generally comprises a transmitter (or headend) 202 and a receiver 204. The transmitter may have an output 206 that presents a signal (e.g., TRANSPORT_STREAM). The signal TRANSPORT_STREAM may be presented to an input 208 of the receiver 204. The transmitter 202 may be implemented as a headend. The receiver 204 may be implemented as a set top box. The receiver 204 may be implemented as a satellite receiver box. The transmitter 202 may present multiplexed audio and video data on the signal TRANSPORT_STREAM. The signal TRANSPORT_STREAM may also include system time clock (STC) stamps and audio/video presentation time stamps. The video presentation time stamps may provide timing information for the playback of video data. The audio presentation time stamps may provide timing information for the playback of audio data. The system 200 may synchronize (i) the transmission of the signal TRANSPORT_STREAM between the transmitter 202 and the receiver 204 and (ii) the play back of audio and video data in the receiver 204.

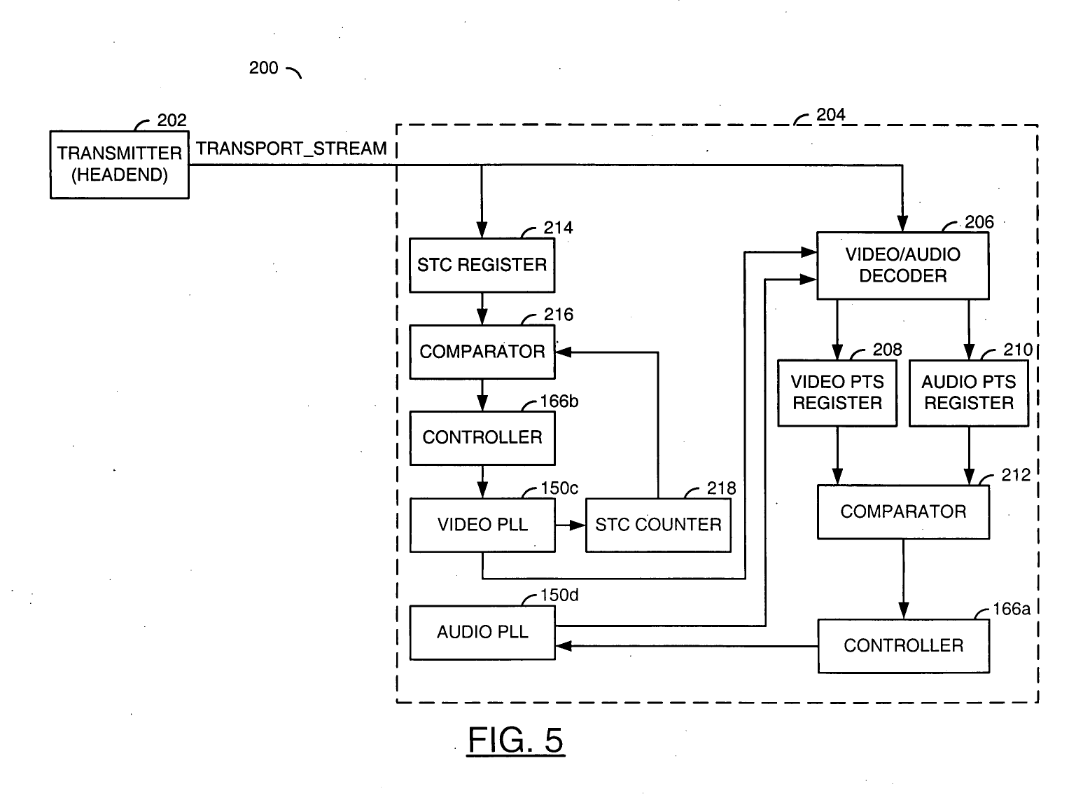

Referring to FIG. 5, a more detailed diagram of the system 200 is shown. The receiver 204 is shown comprising a block (or circuit) 206, a block (or circuit) 208, a block (or circuit) 210, a block (or circuit) 212, the controller 166a, the audio PLL 150d, a block (or circuit) 214, a block (or circuit) 216, a controller 166b, a block (or circuit) 218, and the video PLL 150c. The circuit 206 may be implemented as an audio/video decoder. The circuit 208 may be implemented as a video presentation time stamp (PTS) register. The circuit 210 may be implemented as an audio PTS register. The circuit 212 may be implemented as a comparator. The circuit 214 may be implemented as an STC register. The circuit 216 may be implemented as a comparator. The circuit 218 may be implemented as a system time clock (STC) counter 218.

In general, the system 200 may perform A/V synchronization. The video PLL 150c may provide the video clock signal to the video/audio decoder 206. The video/audio decoder 206 may decode encoded video data and video presentation time stamps from the signal TRANSPORT_STREAM based on the rate of video clock signal. The audio PLL 150d may present the audio clock signal to the audio decoder 206. The video/audio decoder 206 may decode the encoded audio data and the audio presentation time stamps based on the rate of the audio clock signal. When a frame of video is displayed and transferred on the signal TRANSPORT_STREAM, a video presentation time stamp may be extracted from the original video stream. The video presentation time stamps may be stored in the video PTS register 208. When a frame of audio is displayed and transferred on the signal TRANSPORT_STREAM, an audio presentation time stamp may be extracted from the original audio stream. The audio presentation time stamp may be stored in the audio PTS register.

The comparator 212 may compare the video presentation time stamps stored in the video PTS register 208 that arrived with video data in a particular frame against the audio presentation time stamps in the audio PTS register 210 that came with audio data in a particular frame for every frame of video or audio that is displayed. If the audio presentation time stamp drift apart from the video presentation time stamps, the controller 166a may adjust the fractional divider of the audio PLL 150d to slightly tune up or down the audio PLL frequency (e.g., adjust the frequency of the audio clock signal during the audio decoding process). The audio PLL 150d may adjust the audio clock signal in response to being tuning by the controller 166a. The video/audio decoder 206 may decode the audio data and extract the audio presentation time stamps based on the rate of the new audio clock signal. In response, the audio presentation time stamps and the video presentation time stamps may be synchronized with each other over time.

In general, the video data rate may be much higher than the audio data rate. The video data and audio data may be sent by the transmitter 202 in packets. A larger number of video data packets may be received by the receiver 204 than the number of audio data packets due to the higher video data rate. An MPEG encoder (not shown) may generate the presentation time stamps independently for the video and audio data. Since the video PLL 150c is separate from the audio PLL 150d, the corresponding frequencies of the video and audio PLL may drift apart from each other. The system 200 may adjust the frequency of the audio PLL 150d (via the controller 166a) to reduce the drift. The video and audio presentation time stamps provides a mechanism for (i) assembling the audio and video packets of data in a correct order for playback and (ii) tuning the video and audio presentation time stamps to ensure that the video and audio presentation time stamps are in sync with each other.

In another example, the controller 166a may adjust the fractional divider of the video PLL 150c to slightly tune up or down the video PLL frequency (e.g., adjust the frequency of the video clock signal during the video decoding process). The video PLL 150c may adjust the video clock signal in response to being tuned by the controller 166a. The video/audio decoder 206 may decode the video data and extract the video presentation time stamps based on the rate of the new video clock signal. In response, the video presentation time stamps and the audio presentation time stamps may be synchronized with each other over time. The control of the frequency for either the video PLL 150e or the audio PLL 150d may be varied to meet the design criteria of a particular implementation.

The system 200 may synchronize the playback of audio and video data between the headend equipment 202 and the receiver (or set top box) 204. As the receiver 204 receives the signal TRANSPORT_STREAM, STC stamps may be extracted and stored in the STC register 214. In one example, the video PLL 150c may present the video clock signal to the STC counter 218. The STC counter 218 may generate and store a local version of the STC stamps in the STC counter 218. In general, the receiver 204 may use a 27 MHZ clock signal to drive the STC counter 218. In response, the STC counter 218 may generate the local verison of the STC stamps based off of a 27 MHZ clock signal. The particular frequency used to drive and generate the local version of the STC stamps may be varied to meet the design criteria of a particular implementation. The transmitter 202 may use a 27 MHZ clock to drive a counter (not shown) in order to generate the STC stamps transmitted over the signal TRANSPORT_STREAM. The particular frequency used to drive the counter which generates the STC stamps over the signal TRANSPORT_STREAM may be varied to meet the design criteria of a particular implementation.

In another example, the audio PLL 150d may drive the STC counter 218 with the audio clock signal. The STC counter 218 may generate and store the local version of the STC stamps based on the rate of the audio clock signal. The comparator 216 may compare the STC stamps stored in the STC register 214 against the local STC stamps in the STC counter 218 at predetermined times. If the local version of the STC stamps drift apart from the stored STC stamps, the controller 166b may adjust the fractional divider of the video PLL 150c such that the local STC stamps and the extracted STC stamps are synchronized overtime. If the audio PLL 150d is used to drive the STC counter 218, then the controller 166b may adjust the fractional divider of the audio PLL 150d when the local STC stamps drifts apart from the extracted STC stamps. In general, without receiver and transmitter synchronization, the receiver 204 may have a number of input/output buffers in overflow or underflow conditions.

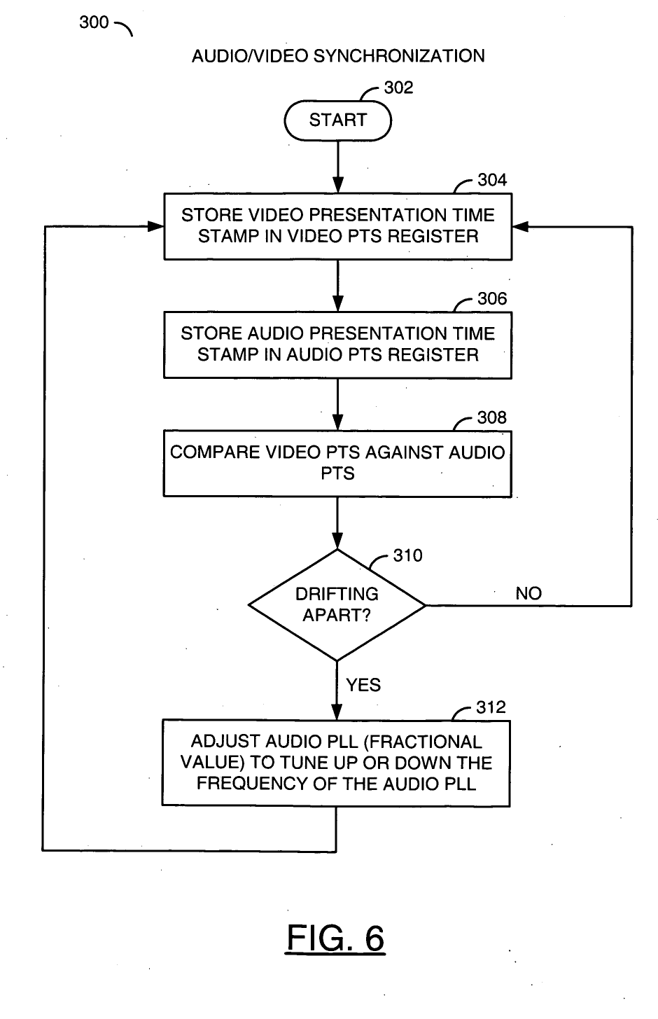

Referring to FIG. 6, a flow diagram (or method) 300 showing an audio/video synchronization process is shown. The method 300 generally comprises a state 302, a state 304, a state 306, a state 308, a decision state 310 and a state 312. The state 304 may store video presentation time stamps in the video PTS register 208. The state 306 may store an audio presentation time stamp in the audio PTS register 210. The state 308 may compare the video presentation time stamps for video data of a particular frame against the audio presentation time stamps for audio data for a particular frame. The decision state 310 may determine if the video presentation time stamps drift apart from the audio presentation time stamps for every frame of video data or audio data that is to be displayed. If the video presentation time stamps do not drift from the audio presentation time stamp the method 300 moves back to the state 304. If the video presentation time stamps drift apart from the audio presentation time stamps, then method 300 moves to the state 312. The state 312 adjusts the audio PLL 150d to tune the frequency of the audio PLL 150d either up or down. The audio PLL 150d may adjust the audio clock signal in response to performing step 312. The audio/video decoder 206 may decode the audio data and extract the audio presentation time stamps based on the rate of the new audio clock signal. After the state 312, the method 300 moves back to the state 304.

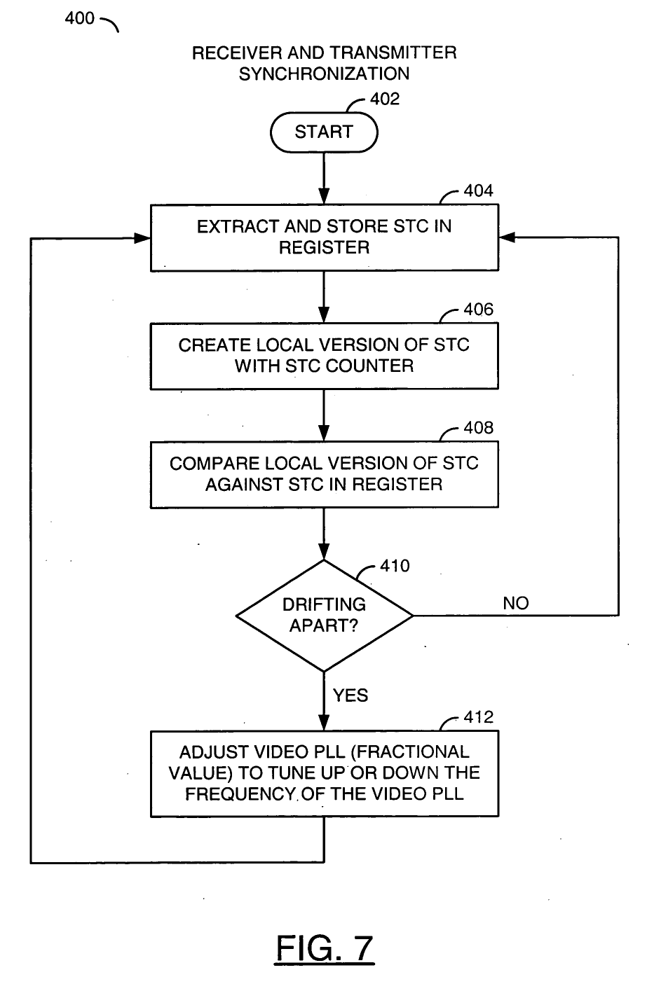

Referring to FIG. 7, a method 400 is shown illustrating a receiver and transmitter synchronization process. The method 400 generally comprises a state 402, a state 404, a state 406, a state 408, a decision state 410 and a state 412. The state 404 extracts and stores an STC stamps in the register 214. The state 406 creates a local version of the STC within the STC counter 218. The state 408 compares the local version STC stamps against the extended STC stamps stored in the STC register 214. The decision state 410 determines whether the local STC stamps drift apart from the extracted STC stamps. If not, the method 400 moves back to the state 404. If the local STC stamps drive apart from the extracted STC stamps, the method 400 moves to the state 412. The state 412 adjusts the video PLL to up or down the frequency to match the audio PLL. Next, the method 400 moves back to the state 404.

In general, the system 200 may solve a number of problems related to the transmission of video/audio data between a transmitter 202 and a cable set top box (or satellite receiver box 204). The headend 202 may send a number of bits (or a bitstream) on the signal TRANSPORT_STREAM to the receiver 204. However, if there is a long term drift between the clock frequency of the headend 202 and the receiver 204, an input buffer underflow or overflow may occur. For example, the clock of the headend 202 may be operating at 26.99 MHz and a clock for the set top box 204 may be operating at 27.01 MHz. Such a condition may demonstrate that the set top box 204 may be displaying video data slightly faster than the video data provided by the headend 202. Eventually, the set top box 202 may run out of video data to display.

In one example, the headend 202 may provide 2699 frames of video/data while the set top box 204 displays 2701 frames. As such, the set top box 204 may be 2 frame short once at various instances. Due to such a shortage, the set top box 204 may either hang, or display a black screen at various instances. The set top 204 may also have to repeat the same frame every once in a while. Such a condition may be known as buffer underflow. The opposite condition (e.g., the set top box 204 displays video data at a faster rate than video data is received) is buffer overflow. Due to such an overflow condition, the set top box 204 may need to throw away frames. Such a condition generally results in a movie appearing to be jerky.

The present invention may eliminate overflow and underflow conditions. In general, the headend 202 may include a timer driver which is driven by a headend clock. Such a timer may be used to create the STC stamps. Such STC stamps may be inserted into the signal TRANSPORT_STREAM. The receiver 204 may also have a timer driven by a dedicated clock. The receiver 204 may (i) extract the STC stamps from the MPEG transport stream (ii) compare the STC stamps in the TRANSPORT_STREAM against localized STC stamp generated in the receiver 204 to determine if the receiver clock is faster or slower when compared with the headend clock. A video and/or fractional PLL may be tuned to ensure the local STC stamps match the STC stamps on the signal TRANSPORT_STREAM. Conventional systems need to tune external voltage control oscillators in order to synchronize the transmission of STC stamps between the transmitter 202 and the receiver 204.

The present invention also synchronizes the playback of video and audio data. In general, the audio and video data are captured separately from the original source. The audio and video data are presented separately on the signal TRANSPORT_SYSTEM. In addition, the video data rate may be higher than the audio date rate. The video and audio data may be sent in packets. A large number of video packets may be sent for a long period of time, while one or two audio packets may be sent by the transmitter 202. Due to the transmission, audio and video packets may be out of sync with each other.

In general, the MPEG encoder may time stamp the audio and video packets with presentation time stamps independently of each other. Since separate PLLs may be used for audio and video, the corresponding frequency between audio and data packets may drift from one another. Due to such drift, the audio might be played back slightly faster or slower than the video. Due to such playback, the audio buffer may experience an underflow or overflow condition. The present invention solves this problem by comparing the video presentation time stamps against the audio presentation time stamps for every frame of audio or video that is displayed. The comparison of audio presentation time stamps to video presentation time stamps may indicate whether the video PLL 150c is faster or slower than the audio PLL 150d. The controller 166 may adjust the video PLL 150c or the audio PLL 150d. The present invention allows (i) audio and video packets to be presented in a correct order and (ii) audio and video packets to be tuned to each other to ensure proper synchronization.

While the invention has been particularly shown and described with reference to the preferred embodiments thereof, it will be understood by those skilled in the art that various changes in form and details may be made without departing from the scope of the invention.

1. An apparatus comprising:
a first circuit configured to present a transport stream having (i) audio/.video data, (ii) video presentation time stamps, and (iii) audio presentation time stamps, and
a second circuit having one or more phase locked loop circuits and a control circuit, wherein said control circuit is configured to synchronize the playback of said audio/video data by adjusting a fractional divider of one or more of said phase locked loop circuits.

2. The apparatus according to claim 1, wherein said phase locked loop circuit is configured to generate an audio clock signal having a clock frequency varied based on the adjustment of said fractional divider.

3. The apparatus according to claim 2, wherein said phase locked loop circuit configured to generate a video clock signal having a clock frequency varied based on the adjustment of said fractional divider.

4. The apparatus according to claim 3, wherein said second circuit comprises a video/audio decoder configured to extract said video presentation time stamps and said audio presentation time stamps from said transport stream.

5. The apparatus according to claim 4, wherein said second circuit comprises a comparator configured to compare said video presentation time stamps with said audio presentation time stamps.

6. The apparatus according to claim 5, wherein said control circuit is configured to adjust said fractional divider of said phase locked loop circuit when said video presentation time stamps drift apart from said audio presentation times stamps in response to said comparator comparing said video presentation-time stamps with said audio presentation time stamps.

7. An apparatus comprising:
a first circuit configured to present a transport stream having (i) audio/video data, (ii) video presentation time stamps, (iii) audio presentation time stamps and (iv) system time clock stamps, and
a second circuit having one or more phase locked loop circuits and a control circuit and configured to receive said transport stream, wherein said control circuit is configured to synchronize the transmission of said transport stream between said first circuit and said second circuit during the playback of said audio/video data by adjusting a fractional divider of said one or more phase locked loop circuits.

8. The apparatus according to claim 7, wherein said second circuit comprises a register configured to store system time clock stamps extracted from said transport stream.

9. The apparatus according to claim 8, wherein said second circuit comprises a counter configured to generate a local version of said system time clock stamps.

10. The apparatus according to claim 9, wherein said second circuit comprises a comparator configured to compare said system time clock stamps against said local version of said system time clock stamps.

11. The apparatus according to claim 10, wherein said control circuit is configured to adjust said fractional divider of said one or more phase locked loop circuits when said system time clock stamps drift apart from said local version of said system time clock stamps in response to said comparator comparing said video presentation time stamps with said audio presentation time stamps at predetermined times.

12. The apparatus according to claim 11, wherein said one or more phase locked loop circuit generates one or more audio/video clock signals having a clock frequency varied based on the adjustment of said fractional divider.

13. The apparatus according to claim 7, wherein said one or more phase locked circuits are configured to generate one or more clock signals selected from the group consisting of a USB compliant clock signal, a firewire compliant clock signal, a video decoder clock signal, a memory clock signal, a video clock signal, a system clock signal, an audio clock signal, and a video decoder clock signal.

14. A method for synchronizing the transmission of audio/video data between a receiver and a transmitter, comprising the steps of:
(a) presenting a transport stream having (i) said audio/video data, (ii) video presentation time stamps (iii) audio presentation time stamps and (iv) system time clock stamps;
(b) receiving said transport stream; and
(c) synchronizing a playback of said audio/video data by adjusting a fractional divider of a phase locked look circuit.

15. The method according to claim 14, further comprising the step of:
generating an audio clock signal having a clock frequency varied based on the adjustment of said fractional divider.

16. The method according to claim 15, further comprising the step of:
extracting said video presentation time stamps and said audio presentation time stamps from said transport stream.

17. The method according to claim 16, further comprising the step of:
comparing said video presentation time stamps with said audio presentation time stamps.

18. The method according to claim 17, further comprising the step of:
adjusting said fractional divider when said video presentation time stamps drift apart from said audio presentation time stamps.

19. The method according to claim 14, further comprising the step of:
synchronizing the transmission of said transport stream during the playback of said audio/video data by adjusting a fractional divider of said phase locked loop circuit.

20. The method according to claim 19, further comprising the step of:
generating a local version of said system time clock stamps; and
comparing said system time clock stamps against said local version of said system time clock stamps.
